(19) United States
(12) Patent Application Publication
(10) Pub. No.: US 2016/0292731 A1
(43) Pub. Date: Oct. 6, 2016

(54) CONTEXTUAL REAL-TIME MARKETING

(71) Applicant: Farid Khwaja, Dubai (AE)

(72) Inventor: Farid Khwaja, Dubai (AE)

(21) Appl. No.: 14/715,425

(22) Filed: May 18, 2015

Related U.S. Application Data
(60) Provisional application No. 61/954,849, filed on Mar. 18, 2014.

(51) Int. Cl. G06Q 30/02

(52) U.S. Cl. CPC G06Q 30/0255

(57) ABSTRACT

A method and system for real-time targeting of advertisements and promotional offers to users of mobile wallet in a proactive as well as reactive manner is described. Targeting is based on a set of information associated with real-time transaction history of mobile wallet users.

### CROSS REFERENCE TO RELATED APPLICATIONS AND CLAIM TO PRIORITY

This non-provisional application claims priority to and benefits under 35 U.S.C. §119(e) to U.S. Provisional Application No. 61/954,849 filed on Mar. 18, 2014, entitled “Contextual Real-time Marketing”, the disclosure of which is incorporated by reference herein in its entirety.

### FIELD OF THE INVENTION

The present invention relates to targeted delivery of marketing offers, loyalty offers, microfinance offers, peer-to-peer and targeted advertisements.

### BACKGROUND OF THE INVENTION

Advertising is one of the main sources of increasing sales of products or services for companies. A vendor/service provider or any advertiser would always like to spend their advertising money in the most effective manner possible. Different advertising techniques are used by the companies to promote the sale of goods and services such as, but not limited to, basic pay-per-click advertising, pop-up ads, on-line videos or games with an advertising component incorporated therein.

The advertising will be effective only if it is targeted to a potential customer. Various types of criteria are used to identify the potential customers. The existing targeted advertising method is mostly search based (as in case of search engines; Google), “like” based (as in case of Facebook), keywords based in emails (as in case of Gmail). Using “search” or “likes” as the criteria for targeting advertisements is not so accurate. Search may be used just to feed the curiosity of the customer. Current advertising methods are disbursed in a broadcast manner and do not take into consideration the actual real time contextual information of the customer.

Hence, there is a need for a method that solves the above-identified problems and provides a better solution for targeting the promotions/offers/ads to a potential customer. Further, an improved method is required that promotes the public to participate in the advertiser's campaign.

### SUMMARY OF THE INVENTION

The invention may be designed to provide a system and method for targeting advertisements and promotional offers in real-time to users of mobile wallet in a proactive as well as reactive manner.

The invention may be designed such that the Contexto (see definitions in paragraph 23, below) mobile wallet may be linked with a credit card, debit card, prepaid scratch cards or by ATM machine using QR codes. Further, the Contexto mobile wallet may be used to purchase goods/services from the online merchants without visiting their location.

The invention may be designed such that Contexto mobile wallet applications may be used in point of sale machines such as, but not limited to, scanners at merchant locations.

The invention may be designed to provide cloud based Contexto platform that acts as an interface between Contexto scanner and service provider bank. The Contexto platform may map the customer details with the merchandise details and stores it in a Contexto database. It may also store the actual transaction details conducted by user of mobile wallet. The actual transaction details can be such as, without limitation, (a) merchant details with which the user has conducted a transaction, (b) details of purchased items, (c) user details in case of money transfer between users, and/or (d) location of the merchant. Any other parameter can also be stored and/or shared at the discretion of users of mobile wallets. Further, actual identity or name of the mobile wallet user may be excluded from the shared details.

The invention may be designed to store data of all transactions that are conducted with the use of Contexto mobile wallet. Storage may be done in a centralized secure intelligent database of the Contexto platform.

In accordance with one aspect of the invention, there is a provided a method and system for targeting advertisements and promotional offers to a user of a mobile wallet in real-time in a proactive as well as reactive manner based on a set of information associated with transaction history of the mobile wallets user. Since the targeting is based on real-time and contextual information associated with the mobile wallet user, the method is far more accurate than any other means currently used for reactive/proactive delivery of targeted advertisements. Further, the present invention takes into account the frequency-of-purchase, location-of-purchase and socio-economic class of the user to make the targeted advertising more effective.

In accordance with a second aspect of the invention, ads can be targeted to a user during an online session when the user is accessing content from a publisher. The ads are targeted on the basis of set of information associated with a user device. The set of information associated with user device can be an IP address of the user device, a user agent of the user device, a phone number of the user device, an IMEI number of the user device, a carrier of the user device, a location/demographic information of the user device, a device description associated with the user device, etc.

A mobile wallet is a payment platform which stores the user's payment information and enables the user to quickly pay for the online/in-store purchases without using the physical credit card. A mobile wallet is similar to a virtual prepaid card that allows the user to securely shop wherever he wants through the mobile wallet payment application. The mobile wallet application can be installed on a computer, cell phone, tablet, smart-phone or on any similar user device. The concept of a mobile wallet falls under the category of non-coin based currency systems. Instead of paying with cash, check, or credit cards, a consumer can use a mobile phone to pay for a wide range of services and products.

The Contexto mobile wallet provides the mobile wallet functionality along with the feature of contextual advertising/targeting ads to the user. The functionality of user device is extended with the Contexto mobile wallet. The Contexto mobile wallet can be such as, but not limited to, a mobile app installed in the user device, a cloud based software platform that can be accessed by using the web-based interface on user device and a browser-based plug-in. The Contexto mobile wallet can be linked to the predefined payment source, i.e., credit card account, checking account, savings/current account, debit card account, prepaid scratch cards, membership account, etc., associated with the user that is provided by a bank, financing company, merchant, governmental entity, or the like.

### BRIEF DESCRIPTION OF THE DRAWINGS

FIG. 1 illustrates an exemplary Contexto scanner at the point of sale according to an embodiment of the present invention;

FIG. 2 shows an exemplary system for payment capturing according to an embodiment of the present invention;

FIG. 3 illustrates a computer implemented method for making payments using Contexto mobile wallet;

FIG. 4 illustrates a first exemplary embodiment for targeting advertisements using cloud-based Contexto platform; and

FIG. 5 illustrates a second exemplary embodiment for targeting advertisements to potential users.

### DETAILED DESCRIPTION OF THE PREFERRED EMBODIMENT

Embodiments of the present invention are best understood by reference to the detailed figures and description set forth herein. These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The terms “user”, “customer”, “consumer”, “client,” and the plural form of these terms are used interchangeably throughout herein to refer to those who would access, use, request, and purchase services/goods by using the Contexto-based system of the present invention.

The terms “vendor”, “merchant”, “retailer”, and the plural form of these terms are used interchangeably throughout herein to refer to those who would publish, sell, advertise, and trade-in by using the Contexto-based system of the present invention.

The term “Contexto” here refers to a method, a device, an application, a platform that uses the contextual real-time transaction information of users for targeting advertisements. The advertisements can be, but are not limited to, marketing and loyalty offers, promotional offers, microfinance offers, and peer-to-peer and/or targeted advertisements to users. The application can be any desktop-based software, mobile app, add-on, plug-in, browser-based software, mobile widgets, desktop widgets, or any other software known in the art.

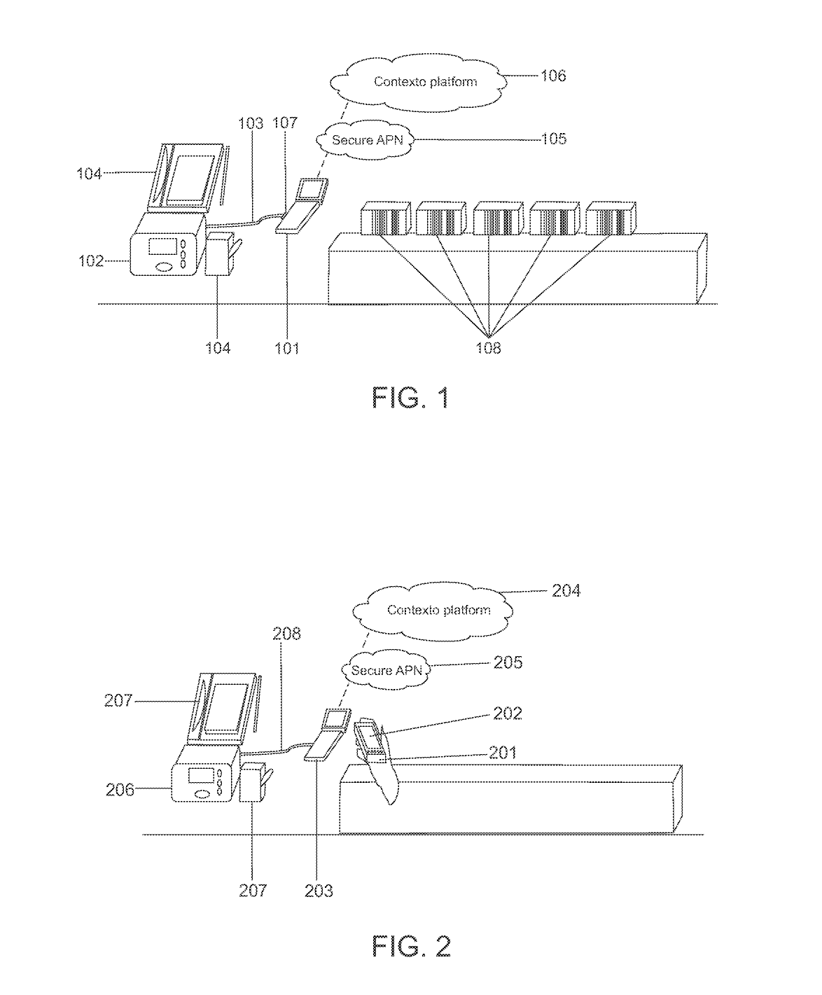

FIG. 1 illustrates a system for targeting advertisements and promotional offers to a user in accordance with an exemplary embodiment of the present invention. The advertisements can be related to such as, but not limited to, marketing and loyalty offers, microfinance offers and peer-to-peer and/or targeted advertisements to users. The system comprises: a Contexto scanner 101, a cash register 102, a link (communication line) 103, an output device 104, a secure network 105, a cloud-based Contexto platform 106 and a physical interface 107 on Contexto scanner 101.

The Contexto scanner 101 is provided at the point of sale at merchant side. The Contexto scanner 101 is connected to the cash register 102 through the link 103. The link 103 can be any communication line, for example, without limitation, RS232, USB link, serial link. The cash register 102 is used to calculate the cost of a product, the sales tax and calculates the total value of the product.

The Contexto scanner 101 communicates with the cash register 102 via the interface 107. The interface 107 is a port for connecting the communication line 103 to the scanner 101. The interface 107 can be such as, but not limited to, USB port, RS232 port and serial port.

The Contexto scanner 101 can scan any kind of codes for example, without limitation, bar code, QR code. Thus, while this description refers to using QR codes, it will be understood that “QR code” also covers other coding techniques as well.

The cash register 102 is coupled with output devices 104. The output devices 104 comprise such as, but not limited to, display screen for displaying the purchase related data to the merchant/vendor, printer for printing out the physical receipt of the purchase, etc. The printers, displays, and other output devices 104 provide a visual and/or hard copy of information for reviewing the information, for instance by printing or displaying purchase related information.

The Contexto scanner also has a 3G/4G interface. The Contexto scanner connects over a secured dedicated APN 105 to cloud based Contexto platform 106 using the data connectivity over 3G/4G.

In one embodiment, the customer presents his merchandise 108 to the retailer for billing. The cashier at retailer scans the merchandise bar codes by using the Contexto scanner 101. The details of merchandise scanned are transmitted to the cash register 102. The cash register 102 calculates the total cost of the merchandise by considering the cost of the merchandise, the sales tax, discount, etc. The total calculated cost is then displayed on the screen 104 where the customer as well as merchant can review the price of the merchandise 108. The scanned details of merchandise 108 are transmitted to the Contexto platform 106 over 3G/4G secure data connectivity.

FIG. 2 shows an exemplary system for payment capturing at the point of sale according to an embodiment of the present invention. A customer is provided with a user device 201 which is equipped with a Contexto mobile wallet 202. The user device 201 can be any computerized electronic device, for example, without limitation, a mobile device, a handheld device, a tablet, a pager, a wireless terminal, a personal digital assistant (PDA), a personal computer, a microcomputer, a work station, a notebook computer, a hand held personal computer (PC), or any data processing apparatus.

The functionality of the user device 201 is extended with the Contexto mobile wallet 202. In one aspect, the Contexto mobile wallet 202 is a mobile app installed in the user device 201. In another implementation, the Contexto mobile wallet application is a cloud-based software platform that can be accessed by using the web-based interface on user device 201. In yet another implementation, the functionality of the Contexto mobile wallet 202 may be incorporated in the user device 201. The Contexto mobile wallet 202 may include software, hardware, or a combination thereof, resident on the user device 201 that includes one or more linked accounts. The Contexto mobile wallet 202 can also be used to purchase goods or services from online merchants without visiting the merchant location.

The Contexto mobile wallet 202 can be linked to the predefined payment source, i.e., a credit card account, a checking account, a savings/current account, a debit card account, a prepaid scratch card, a membership account, etc., associated with the user that is provided by a bank, a financing company, a merchant, a governmental entity, or the like. Further, the user can optionally define usage limit for Contexto mobile wallet 202. Usage limit can be configured on daily or hourly or per transaction basis.

In one implementation, the Contexto scanner 203 at the merchant side has a 3G/4G interface. The Contexto scanner 203 connects over a secured dedicated APN 205 to Contexto platform 204 using the data connectivity over 3G/4G. In other implementations, Contexto scanner 203 can use the internet connectivity of the merchant side computer (not shown) for connecting to the Contexto platform 204 over the secured APN 205. Further, the Contexto scanner 203 can also use any other data connectivity method such as, but not limited to, LAN (local area network), WLAN (wireless local area network), Hotspot technique, or the like.

Contexto platform 204 is a centralized cloud based system that is configured to provide benefits to multiple providers and users. It includes at least one processor (not shown) and a module of code (which may be stored in a storage medium locally or downloaded from a remote server) executed by the processor for filtering the set of potential marketing and loyalty offers, microfinance offers and peer-to-peer and targeted advertisements based at least in part on one or user transaction related details and/or set of information associated with the user device 201. The Contexto platform 204 can be linked with any online publisher and can provide ads to the user visiting that site by tracking the information associated with the user device 201. The publisher can be any third party that provides online content to the user.

The Contexto platform 204 may be configured to store purchase related information for multiple customers and map the merchandise details with customer details. It also stores the real-time transaction history of the customers, frequency of the purchase, location of the purchase, social class of the customers, or other related contextual information of the customers. In one embodiment, the merchant and customers may access the Contexto platform 204 using the Contexto mobile wallet application installed on their respective devices. In another aspect of the invention, customers/merchants may access, via a browser, a web page that provides an entry point to the Contexto platform 204. In an embodiment, when a merchant/customer access the Contexto platform 204, he/she may be asked to provide authentication credentials. Further, the Contexto platform 204 provides the targeted advertisement to the potential customers based on a set of information associated with actual real-time transaction history of the customers. Ads can also be targeted on the basis of set of information associated with a user device 201. The set of information associated with user device 201 can be such as an IP address of the user device, a user agent of the user device, a phone number of the user device, an IMEI number of the user device, a carrier of the user device, a location/demographic information of the user device, a device description associated with the user device, etc. Actual identity or name of the mobile wallet user can be excluded from the set of information associated with the user device 201.

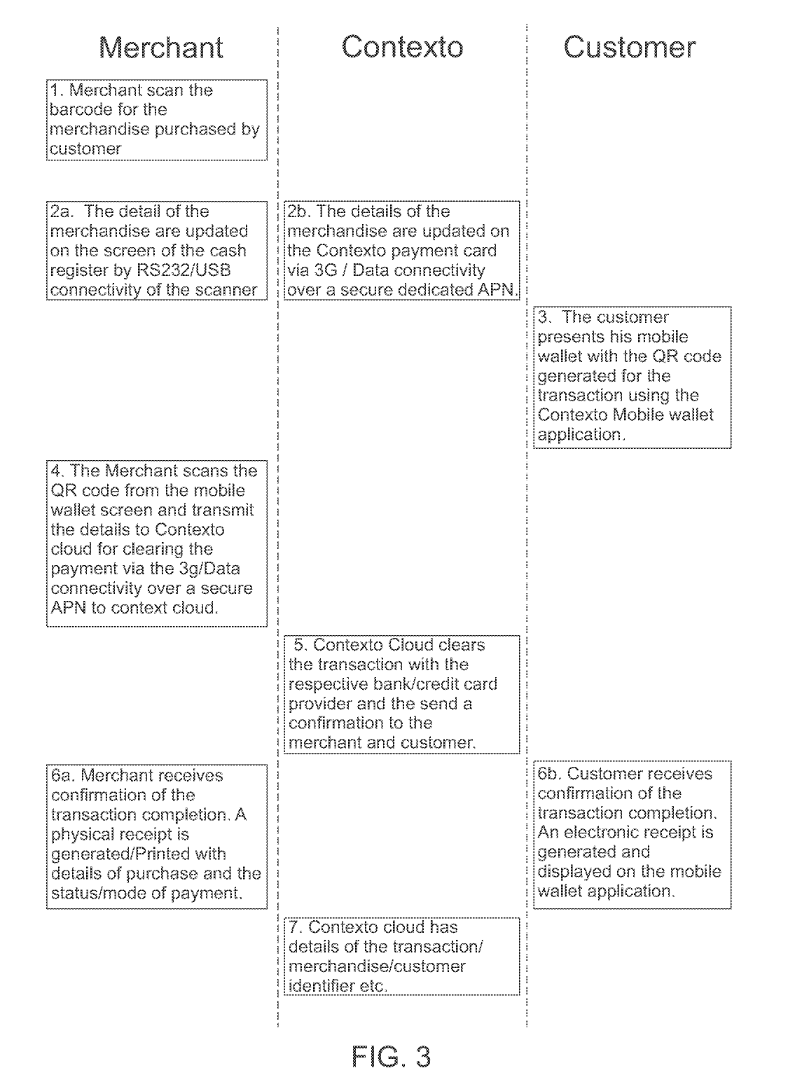

Referring to FIG. 3, when a customer purchases some merchandise, the merchant scans the barcode of purchased merchandise by using the Contexto scanner 203. The scanned details are then transmitted to the cash register 206 over RS232/USB connectivity 208. The cash register 206 calculates the total price of the merchandise by considering various parameters such as, but not limited to, the cost of the merchandise, the sales tax, discount etc. The cost of the merchandise is then updated on the Contexto platform 204 over the secured dedicated APN 205 via the 3G data connectivity. The customer selects at least one predefined payment source from such as, but not limited to, a credit card account, a savings account, a debit card account, or the like using the Contexto mobile wallet 202 and a QR code is generated dynamically on the cloud-based Contexto platform 204.

The QR code is time bounded for increasing the security of the transactions, i.e., the QR code will be valid only for a predetermined duration. The customer presents the QR Code to the retailer to complete the transaction by using his Contexto mobile wallet 202. The retailer scans the QR code using the Contexto scanner 203. The information is transmitted to Contexto platform 204 over the secured dedicated APN 205. The Contexto platform 204 maps the merchandise details with customer details. In parallel, the Contexto platform 204 sends the information to credit card/provide bank to authorize the transaction. Once approved, a confirmation is sent to merchant on the display of the Contexto scanner 203 and the printer 207 attached to the Cash Register prints a physical receipt. An electronic copy of the receipt is also generated and sent to the customer using Contexto mobile wallet 202.

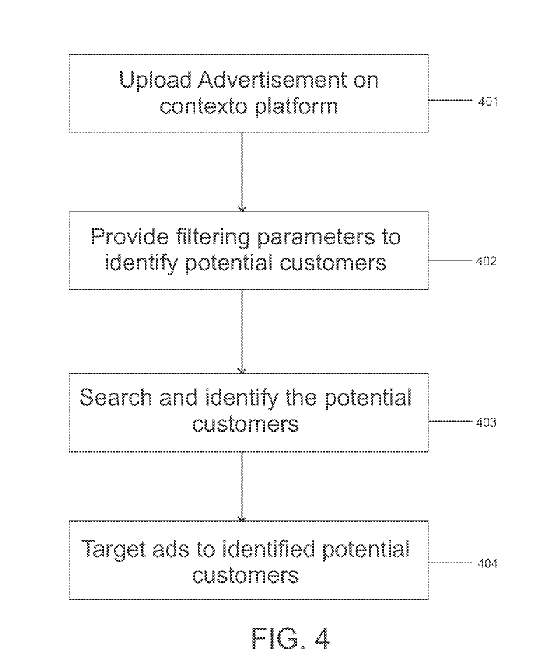

FIG. 4 illustrates the flowchart for an exemplary embodiment in which the merchant of a retail store can use Contexto advertising system. In this embodiment, the Contexto platform is being used for targeted advertisement/marketing in which the retailer of a retail store is interested in putting up an offer to clear the inventory or stock under some discount offer. In FIG. 4, the flowchart illustrates the step-by-step process of targeted marketing using the exemplary embodiment of retailer-to-customer advertising system making use of Contexto platform.

For instance, a retail store has accumulated high inventories of certain perishable items, which are approaching their expiration date within eight (8) weeks. The retail store is interested in putting up an offer to clear the inventory. The retail store has options to list their offers in a small seasonal discount coupon booklet or use print advertisements with summary of their offers, use the cable operator for TV advertisements, use emails to send such offers to customers or advertise with Contexto.

Initiating the process with step 401, the retail merchant uploads his advertisement related to offers/discount schemes which can be in the form of, but not limited to, media, textual, banner consisting of images as well as text, or any other combination possible. The advertisement, in any form, contains all the ad specifications put in by the retailer which attracts the customer for the deal. The advertisement is uploaded by the merchant on the Contexto platform at the retailer's side which can be any software application, mobile app, online web application or any other related thereto. This Contexto platform is displayed at the screen 104 through the pre-installed application at the retailer's machine and is connected to the cloud-based Contexto platform 204 over the 3G/4G secure data connectivity.

In step 402, the retailer has to specify the parameters for identifying the potential customers for the purpose of contextual advertising. The parameters can be selected from the predetermined available parameters on the application or can be manually added according to the requirement/criteria of the merchant. Current advertising methods/marketing offers are disbursed in a broadcast manner and do not take into account the frequency of purchase, location of purchase and social economic class of the customers. In the present invention, the parameters for the filtering of customers includes, without limitation, the location of customers, class of items purchased previously (for example, if the offer is related to shoes, the customers who bought shoes previously through Contexto, can be filtered for this advertisement), frequency of purchase, social economic class of the customer which is decided on the basis of the spending amount of the customer in the history, and so on.

In step 403, the Contexto database has received the parameters set by the retailer for filtering the potential customers for contextual marketing. Continuing the above example, the retail store will be given a database of customers who on regular basis purchase the perishable items using their Contexto mobile wallet. Details of the neighborhood in which these customers make their purchases will also be shared. The frequency of purchase will also be shared for each customer. Step 403 includes searching for all types of customers asked by the retailer through setting parameters.

In step 404, after agreeing on the parameters for targeting ads by the retailer; Contexto will deliver the targeted offers in the respective Contexto mobile wallet customers provides section at the user's side. Here, the customer will have the option to secure the deal remotely by replying to the merchant's advertisement and make the payment through the online Contexto portal. Merchandise can be collected by customer or can be delivered by the retailer depending on customer preference.

In yet another exemplary embodiment of the present invention, the health instructor can advertise using the peer-to-peer contextual advertising function in Contexto platform. For instance, the health instructor is looking for clients in downtown Chicago Area. He can advertise on Craigslist, local newspaper, on Google, on Facebook or with Contexto. This exemplary embodiment illustrates the utilization of user information (stored in Contexto database) by some party who has not already been enrolled in the transaction process but want its advertisement to be displayed to the potential customers in the related field. The health instructor can upload his credentials using the peer-to-peer advertising function in Contexto platform for targeting the relevant customers. The Contexto software backend will show the advertisement only to customers who have actually paid for a physical health instructor in recent past (for example, twice in last three months). This criteria takes into account the real time spending patterns of the customer. The location-based information of customers will also be used to further target the advertisements to relevant recipients. If the physical health instructor is looking for work in Chicago, his advertisement will be shown to relevant customers in Chicago.

Contexto mobile wallet can be used for peer-to-peer advertising as explained above. It is a contextual type of marketing application that takes into consideration the real-time information about the customer. This set of information is used for filtering the set of potential ads on the user's side, based at least in part on one or more parameters determined. It can be said that as the merchant is filtering the customers on the merchant's side, the ads will automatically get filtered for the customer side as well, wherein, the filtering includes filtering the set of potential marketing and loyalty offers, microfinance offers and peer-to-peer and targeted advertisements based at least in part on one or more user transaction related details determined from one or more parameters included in the set of instruction.

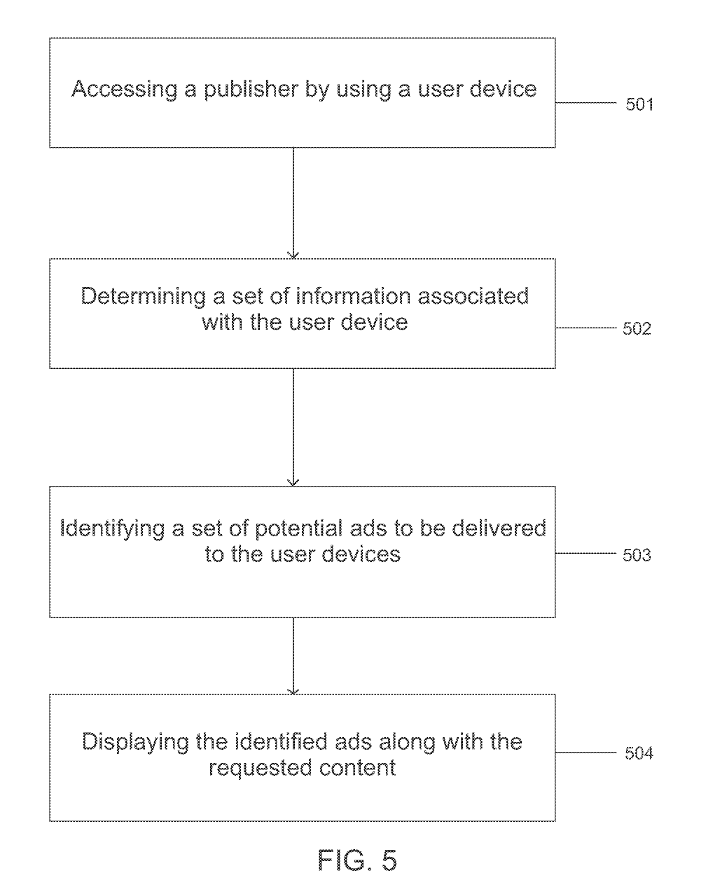

FIG. 5 illustrates a second exemplary embodiment for targeting advertisements to the potential user. In one implementation, process includes steps that can be implemented as instructions and executed in part by a processor (not shown) in the user device 201 and in part by at least one processor (not shown) at a publisher.

The process starts at step 501, where the user is accessing a publisher during an online session by using the user device 201. The publisher can be a third party that provides online content on the basis of the information requested from the user device 201. User of the device 201 may have an account on the accessed publisher. The publisher further includes a module of code that identifies potentials ads for the user by considering various parameters. The module of code is provided by an entity that provides ads on the behalf of the advertiser. In one embodiment, the entity can be the cloud-based Contexto platform 204 and can be linked with the publisher.

In step 502, the module of code at the publisher determines a set of information associated with the user device 201. The set of information includes at least one of the following: an IP address of the user device, a user agent of the user device; an identifier associated with the content requested by the user device; a site identifier associated with a requested site or type of site; a phone number of the user device; an IMEI number of the user device; a carrier of the user device; a location of the user device; a device description associated with the user device; information about a user of the device. The description associated with the user device can be such as a manufacturer of the user device, a model of the user device, a platform of the user device, a capability of the user device, and a feature supported by the user device.

In step 503, the processor at the publisher analyzes the set of information, obtained in step 502, to filter out ads from a set of potential ads to be delivered to the user device along with content requested by the user device from the publisher. The ads are filtered out from the set of potential ads if a targeting parameter associated with the ads does not match a corresponding parameter included in or determined from the set of information. The processor at the publisher executes the module of code provided by an entity to identify the potential ads which are relevant for the user.

The potential ads, identified in step 503, are then displayed along with the content requested by the user on the user device 201.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention. The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A method for targeting advertisements, said method comprising:
determining a set of information associated with real-time financial transaction history of a mobile wallet user, wherein the set of information contains a plurality of parameters;
filtering a set of potential advertisements based at least in part on the parameters included in the set of information; and
selecting at least one advertisement to be delivered to the mobile wallet user, wherein at least one advertisement is selected from the filtered set of potential advertisements.

2. A method as recited in claim 1, wherein the set of information comprises at least one of (i) transaction information associated with the mobile wallet user, and (ii) parameters published at the discretion of the mobile wallet user.

3. A method as recited in claim 2, wherein the transaction information comprises at least one of (i) merchant details, (ii) details of item purchased, (iii) user details in case of money transfer between users, and (iv) details of online merchant in case it is an online transaction.

5. A method as recited in claim 3, wherein the merchant details comprises at least one of merchant location and merchant type.

6. A method as recited in claim 2, wherein the parameters published at the discretion of the mobile wallet user comprises at least one of (i) details of services or products the user intends to sell to other users, (ii) application for microfinance loans/short term loans, and (iii) actual account balances of the mobile wallet user.

7. A method as recited in claim 1, wherein the set of information excludes actual identity of the mobile wallet user, wherein the actual identity comprises at least name of the mobile wallet user.

8. A method as recited in claim 1, wherein one or more parameters included in the set of information are determined by executing a module of code that queries the respective fields of the transaction history.

9. A method as recited in claim 1, wherein the set of potential advertisements comprises at least one of marketing and loyalty offers, microfinance offers, peer-to-peer advertisements, and targeted advertisements.

10. A method as recited in claim 1, wherein filtering is based at least in part on transaction information associated with the user, wherein the transaction information is determined from one or more parameters included in the set of information.

11. A method as recited in claim 1, wherein the set of information comprises the statically configured location of merchant or dynamically discovered location of merchant, which further determines the geographic region associated with the mobile wallet user at the time of transaction.

12. A method for targeting advertisements to a user device, said method comprising:
determining a set of information associated with a user device during a session when the user device is accessing content from a publisher;
filtering a set of potential advertisements based at least in part on the set of information; and
selecting at least one advertisement to be delivered to the user device along with the content requested by the user device, wherein the at least one advertisement is selected from the filtered set of potential advertisements.

13. A method as recited in claim 12, wherein the set of information comprises at least one of an IP address of the user device, a user agent of the user device, an identifier associated with the content requested by the user device, a site identifier associated with a requested site or type of site, a phone number of the user device, an IMEI number of the user device, a carrier of the user device, a location of the user device, a device description associated with the user device, information about a user of the device and a combination thereof.

14. A method as recited in claim 12, wherein said method further comprises determining one or more parameters included in the set of information from at least one of a request for content from the user device, an account of a user of the device at the publisher and a carrier associated with the user device.

15. A method as recited in claim 12, wherein said method further comprises a module of code at the publisher for determining one or more parameters included in the set of information wherein the module of code is provided by an entity that delivers ads on behalf of advertisers.

16. A method as recited in claim 12, wherein filtering comprises identifying the set of potential ads based at least in part on one or more parameters included in the set of information.

17. A method as recited in claim 13, wherein the IP address is used to determine a geographic region of the user device.

18. A method as recited in claim 13, wherein the IP address is used to determine a carrier associated with the user device.

19. A method as recited in claim 13, wherein the user agent is used to determine a device description associated with the user device.

20. A method as recited in claim 19, wherein the device description comprises at least one of a manufacturer of the user device, a model of the user device, a platform of the user device, a capability of the user device, a feature supported by the user device and a combination thereof.

21. A method as recited in claim 12, wherein the set of information comprises information about a user of the device obtained from an account of the user with the publisher.

22. A method as recited in claim 12, wherein the set of information comprises demographic information about a user of the device.

23. A method as recited in claim 12, wherein said filtering further comprises matching the parameters determined from the set of information with one or more targeting parameters associated with an advertisement in the set of potential advertisements.

24. A method as recited in claim 12, wherein one or more advertisements are filtered out from the set of potential advertisements if a targeting parameter associated with the advertisement does not match a corresponding parameter determined from the set of information.

25. A system for targeting advertisements to a user device, comprising:
a processing device configured to execute a module of code to perform:
determining a set of information associated with a user device during a session when the user device is accessing content from a publisher;
filtering a set of potential advertisements based at least in part on the set of information; and
selecting at least one advertisement to be delivered to the user device along with the content requested by the user device, wherein at least one advertisement is selected from the filtered set of potential advertisements.

26. A system as recited in claim 25, wherein the processing device performs filtering by matching one or more targeting parameters associated with advertisements in the set of potential advertisements with corresponding parameters determined from the set of information.

27. A system as recited in claim 25, wherein one or more advertisements are filtered out from the set of potential advertisements if a targeting parameter associated with the advertisement does not match a corresponding parameter determined from the set of information.

28. A computer program product for targeting advertisements to a user device, the computer program product being embodied in a computer readable medium, comprising instructions for:
determining a set of information associated with a user device during a session when the user device is accessing a publisher;
filtering a set of potential advertisements based at least in part on the set of information; and
selecting at least one advertisement to be delivered to the user device along with the content requested by the user device, wherein at least one advertisement is selected from the filtered set of potential advertisements based at least in part on the set of information.

29. A computer program product as recited in claim 28, wherein the computer program product performs filtering by matching one or more targeting parameters associated with advertisements in the set of potential advertisements with corresponding parameters determined from the set of information.

30. A computer program product as recited in claim 28, wherein one or more advertisements are filtered out from the set of potential advertisements if a targeting parameter associated with the advertisement does not match a corresponding parameter determined from the set of information.
